(19) United States
(12) Patent Application Publication
(10) Pub. No.: US 2013/0037686 A1
(43) Pub. Date: Feb. 14, 2013

(54) TOWER LIFT

(71) Applicants: Ralph Cichetti, Montrose, CA (US); David D. MacMurtry, North Hollywood, CA (US); Quang N. Truong, Rosemead, CA (US); Risto M. Salo, Valencia, CA (US); Amanda Uhlein, Wayne, NJ (US)

(72) Inventors: Ralph Cichetti, Montrose, CA (US); David D. MacMurtry, North Hollywood, CA (US); Quang N. Truong, Rosemead, CA (US); Risto M. Salo, Valencia, CA (US); Amanda Uhlein, Wayne, NJ (US)

(21) Appl. No.: 13/208,676

(22) Filed: Aug. 12, 2011

(51) Int. Cl. F16M 11/28; F16M 13/02

(52) U.S. Cl. 248/542; 248/158; 248/125.8; 248/404

(57) ABSTRACT

A lift for raising and lowering a backdrop is provided. The lift includes: a base including at least three legs; a tower boom extending substantially vertically from the base and including top, middle, and bottom telescoping sections, wherein the tower boom is capable of telescoping from a fully retracted position to a fully extended position; and a post extending substantially vertically from the tower boom, wherein the post is detachable from the tower boom at a lower end of the post and attachable to a truss adapted for attaching to a backdrop at an upper end of the post, wherein a minimum height of the tower boom in the fully retracted position is less than about 35% of a maximum height of the tower boom and post, when the tower boom is in the fully extended position.

### FIELD

The present invention relates to a tower lift, and more particularly to a tower lift for raising and lowering backdrops, curtains, and other devices for creating artificial environments.

### BACKGROUND

In theatrical and special event settings, lifts may be utilized to suspend backdrops or curtains to create a desired visual appearance on a stage or in the event space. In these settings, the visual appearance assists in the creation of a desired atmosphere for the theatrical or special event. These backdrops or curtains are typically suspended from trusses, which may be raised up to 20 feet. Furthermore, these backdrops or curtains may be 20 feet or more in length, and multiple lifts may typically be employed along the length of the backdrop or curtain.

To be effective in creating a desired visual appearance, the appearance of the lifts should be minimized so that they do not detract from desired atmosphere. Furthermore, the lifts should be user-friendly so that the lifts are easy to set up and safely suspend the backdrop or curtain.

A typical method of lifting the backdrops is a standard pipe and base system. However, this method requires long, awkward pieces of pipe that are difficult to ship or transport. Further, this type of setup normally requires three to five people and can take about 60 minutes to complete. This method entails building a frame structure on a large open floor that then must be walked upright, or may require large ladders or scissor lifts. A standard 9 feet to 16 feet telescoping upright requires set up to be accomplished at a height of 9 feet 6 inches off the ground, which is difficult and can be dangerous for the user. Furthermore, the maximum cross-member span is 16 feet before an additional vertical support is required. Finally, the pipe and base can be distracting from the visual environment because it is visible at the edges of the backdrop.

### SUMMARY

In an embodiment, a lift for raising and lowering a backdrop is provided. The lift includes: a base including at least three legs; a tower boom extending substantially vertically from the base and including three telescoping sections; and a post extending substantially vertically from the tower boom. The post is detachable from the tower boom at a lower end of the post and attachable to a truss adapted for attaching to a backdrop at an upper end of the post. A minimum height of the tower boom in the fully retracted position is less than about 35% of a maximum height of the tower boom and post, when the tower boom is in the fully extended position.

In another embodiment, the at least three legs may be detachable from the base and may be substantially perpendicular to the tower boom. The tower boom may further include a carrying handle useful for carrying the lift when retracted and disassembled. The base may further include a level, and the at least three legs may include levelers. The lift may include a truss, wherein the truss is attachable to the post.

In another embodiment, a top section of the telescoping sections may include position indicators along a length of the top section. The tower boom may further include a brake winch and a cable, wherein the brake winch and the cable are adapted to extend and retract the telescoping sections. A top section of the telescoping sections may be adapted to be fixed at one of a plurality of locations along a length of the top section with respect to a middle section of the telescoping sections.

In another embodiment, a system for raising and lowering a backdrop is provided. The system includes at least two lifts and a truss. Each lift includes a base, an extendable and retractable tower boom, and a post. Each base includes at least three legs. Each tower boom extends substantially vertically from a base and includes three telescoping sections. Each post extends substantially vertically from the tower boom, and is detachable from the tower boom at a lower end of the post and attachable to a truss at an upper end of each post. The truss is adapted for attaching to the backdrop and an upper end of each post. A minimum height of each tower booms is less than about 35% of a maximum height of each tower boom and post, when the tower boom is in the fully extended position. Also, each top section of the telescoping sections includes position indicators along a length of each top section for determining whether each tower boom of the at least two lifts is extended or retracted to a substantially similar height.

The truss may include a plurality of truss segments. Each of the plurality of truss segments may be no longer than the height of the tower boom in a fully retracted position.

### BRIEF DESCRIPTION OF THE DRAWINGS

FIG. 1 shows a perspective view of a lift in a retracted configuration according to an embodiment of the present invention.

FIG. 2 shows a perspective view of a lift in an extended configuration according to an embodiment of the present invention.

FIG. 3 shows a perspective view of a system of two lifts according to an embodiment of the present invention.

FIG. 4 shows a perspective view of a system of three lifts according to an embodiment of the present invention.

### DETAILED DESCRIPTION

The present tower lift allows a user to attach a backdrop, including backdrops with designs, curtains, or other devices for creating an artificial environment, and to raise this backdrop to a desired height. These backdrops can be utilized to transform a space, such as a tent, a ballroom, a gymnasium, a convention center, a warehouse, an exhibition booth, or a theater without a fly system, into numerous different types of artificial environments, such as a Roman temple, a street scene, or a winter wonderland. Multiple tower lifts may be utilized together with trusses as a system to raise or lower wider backdrops to a desired height, where the system is stable, safe, and user-friendly. The present lift may also be easily configured to have a minimum height of about 5 feet 9 inches so that it may be shipped via standard couriers, such as FedEx or UPS, in a storage container or box.

In an embodiment, two users can operate a system of two lifts to suspend a 25-foot long backdrop at a height of 17 feet in about 15 minutes.

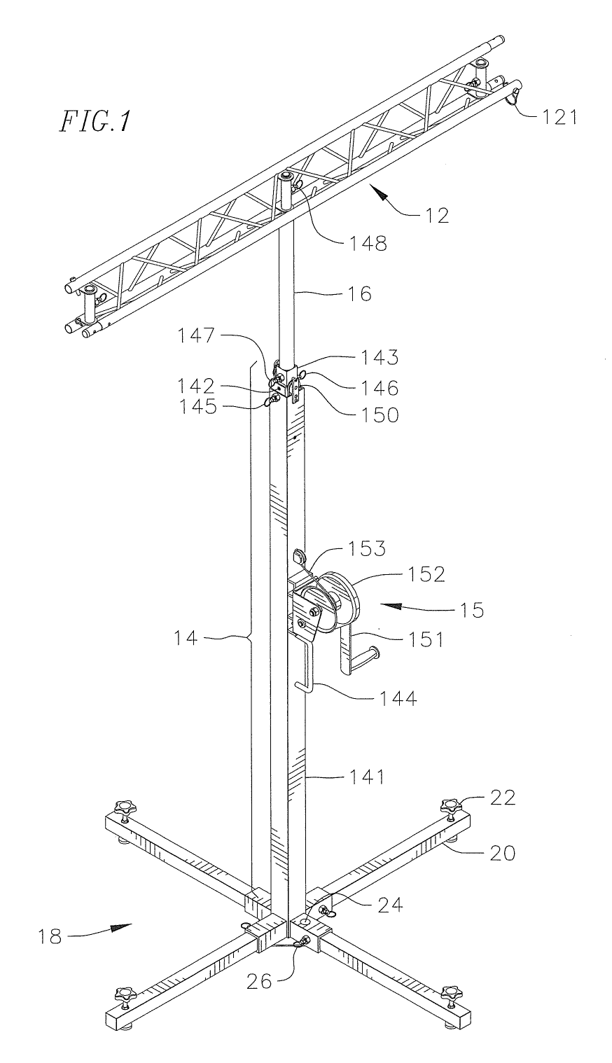

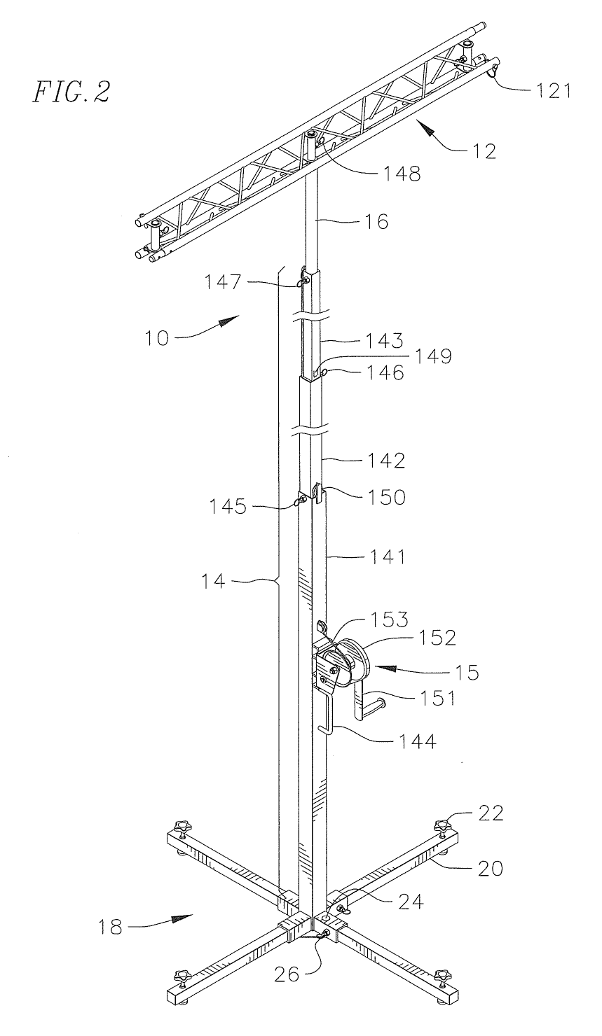

According to an embodiment of the present invention shown in FIGS. 1 and 2, a lift 10 for a backdrop, includes a base 18, a tower boom 14, and a post 16. The tower boom 14 extends substantially vertically from the base 18 and includes three telescoping sections 141, 142, and 143 so that the tower boom 14 may be extended or retracted. The post 16 extends substantially vertically from the tower boom 14, and the post 16 may be detached from the tower boom 14. When the post 16 is detached from the tower boom 14 and the tower boom 14 is fully retracted, the lift 10 is less than one third of the height of the lift 10 when the post 16 is attached to the tower boom 14 and the tower boom 14 is fully extended. Therefore, the height of the lift 10 may be extended to raise backdrops to a desired height, yet may also be retracted so that the lift 10 may be easily transported.

The base 18 includes receptacles for legs 20. Four legs 20 are shown in FIG. 1, however, the base 18 may have other suitable numbers of legs, such as three legs or five legs. Each leg 20 is inserted into a receptacle on the base 18 and is locked in place with a set pin 26, which may be a spring-loaded set pin or any other suitable type of fastener. A user may pull the set pin 26 out to allow the leg 20 to be inserted. Once the leg 20 has been inserted, the user may release the set pin 26 so that the set pin 26 moves into a groove or a hole on the leg 20 and locks the leg 20 in place in the base 18. Further, leg 20 may be removed by pulling the set pin 26 and pulling the leg 20 out of the receptacle. However, one of ordinary skill in the art will appreciate that other suitable methods may be utilized to attach the legs to the base.

Though the legs 20 shown in FIGS. 1 and 2 have square cross-sections, the legs may have any suitable cross-section, such as circular or rectangular.

In an embodiment, levelers 22 are located at distal ends of the legs 20. Each leveler 22 includes a knob located above the leg 20, a foot located below the leg 20 so that it rests on the floor, and a screw section threaded through a leg 20 and coupling the knob to the foot. A user can turn the knob in a first direction to extend the screw section, which then raises the leg 20, or turn the knob in the reverse direction to retract the screw section, which then lowers the leg 20. The user can level the base 18 by adjusting the levelers 22 on each leg 20.

In an embodiment, a bubble level 24 is located on the base 18. While adjusting the levelers 22 to level the base 18, the user may reference the bubble level 24 to determine whether the base 18 suitably adjusted to a level position.

In an embodiment, the legs 20 are substantially perpendicular to the tower boom 14 when the legs 20 have been inserted into the base 18. Further, the legs 20 may be about half an inch to about 5 inches from the ground when the legs 20 have been inserted into the base 18.

In another embodiment, the weight of the lift 10 rests on only the four levelers 22.

The tower boom 14 includes three telescoping sections: a bottom section 141, a middle section 142, and a top section 143, where all sections have rectangular cross-sections. When the tower boom 14 is in a retracted position, the top section 143 is positioned inside the middle section 142, and the middle section 142 is positioned inside the bottom section 141.

Though the sections 141, 142, and 143 of the tower boom 14 shown in FIGS. 1, 2, and 3 have square cross-sections, the sections 141, 142, and 143 may have any suitable cross-section, such as circular or rectangular.

A winch 15 is utilized to extend the tower boom 14. When a handle 151 of the winch 15 is turned in a first direction, a wheel 152 of the winch 15 turns so that a cable 153 is wound around the wheel 152. The use of a winch and cable to extend telescoping sections of a boom is known. For example, the cable 153 and three pulleys may be arranged with one end of the cable 153 fixed near the bottom of the top section 143 of the tower boom 14 and the other end of the cable 153 extending up around a first pulley (not shown) mounted near the top of the middle section 142, down to and around a second pulley (not shown) mounted near the bottom of the middle section 142, then up and around to a third pulley 150 mounted at the top of the bottom section 141, and finally, down to where it is wound about the winch wheel 152. As the cable 153 is wound around the wheel 152, the length of the cable 153 within the sections 141, 142, and 143 is shortened, and the cable 153 pulls the pulleys such that sections 142 and 143 move with respect to each other and the bottom section 141. Here, the middle section 142 will be pulled to extend further from the bottom section 141, and the top section 143 will be pulled to extend further from the middle section 143, such that the length of the tower boom 14 will be extended, as shown in FIG. 2. In the embodiment shown, the cable 153 is mounted inside the various sections 141, 142, and 143 of the tower boom 14 with little of the cable 153 exposed. This helps to keep the cable 153 clean and running smoothly, and prevents the cable 153 from snagging on objects external to the lift 10 such as the operator's clothing, or the backdrop or drapery being supported by the lift 10.

When the handle 151 of the winch 15 is turned in a reverse direction, the length of the cable 153 within the sections 141, 142, and 143 is lengthened, and the weight of sections 142 and 143 lowers these sections 142 and 143 into bottom section 141 as the pulleys roll along the length of the cable 153, as shown in FIG. 1.

In an embodiment, the winch 15 is a self-locking brake winch so that when the handle 151 is not being turned, the winch 15 will remain stationary, the weight of the sections 142 and 143 will not cause the winch 15 to turn, and the height of the tower boom 14 will not change. One of ordinary skill in the art will appreciate that any suitable winch may be utilized in the present invention.

In an embodiment, set pins 145 and 146 may be utilized to lock the position of the sections 141, 142, and 143 with respect to each other. For example, set pin 145 may be utilized to lock the position of the middle section 142 with respect to the bottom section 141, and set pin 146 may be utilized to lock the position of the top section 143 with respect to the middle section 142. These set pins 146 and 147 may be spring-loaded set pins. Further, set pin receptacle configured to receive the set pins 146 and 147 may be positioned along a length of one or both of the sections 146 and 147 or only at the ends of one or both of the sections 146 and 147.

In an embodiment, indicators 149 may be positioned along a length of the top section 143 of the tower boom 14. For example, these indicators 149 may be positioned to indicate one foot intervals. In other embodiments, the indicators 149 may be positioned along the middle section 142. The indicators 149 may be inscribed by a laser, painted, or affixed by any other suitable means. Further, set pin receptacles (or holes) for set pin 146 may be positioned to correspond with each indicator 149 so that the height of the lift 10 can be fixed or locked at these intervals.

One of ordinary skill in the art will appreciate that there are numerous suitable methods of configuring telescoping sections of a tower boom so that the sections may be moved with respect to one another to extend or retract the tower boom, and any suitable method may be utilized in the present invention.

In an embodiment, a carrying handle 144 is located in a suitable position along the tower boom 14. The carrying handle 144 enables a user to more easily move the lift 10.

The post 16 is configured such that a lower end of the post 16 may be inserted into an upper end of the top section 143 of the tower boom 14. The post may be locked into position on the top section 143 with a set pin 147, which may be a spring-loaded set pin. An upper end of the post 16 is configured to engage a receptacle on a truss 12. The post 16 may be locked to the truss 12 with a set pin 148.

In an embodiment, the post is about 30 inches long. In another embodiment, the post is about 18 inches long. Though the post shown in FIGS. 1 and 2 has a circular cross-section, the post may have any suitable cross-section, such as circular or rectangular.

In an embodiment, the truss 12 is a triangular truss, where the truss 12 includes three pipes that are connected by braces such that the truss 12 has a triangular cross-section. This configuration provides improved support for a backdrop as compared to a singular pipe and may prevent the backdrop from sagging. Further, the truss 12 may be formed of truss segments which are configured such that the end of one truss segment may be attached to the end of another truss segment. For example, one or more of the three pipes of one truss segment may be configured for insertion into pipes of another truss segment. Here, the pipes may be locked with respect to each other with pins 121 or any other suitable method. A suitable number of truss segments may then be connected to achieve a desire truss length.

To operate the lift 10, a user would move the lift 10 to a desired location using the handle 144. The user would insert the legs 20 into the base 18 and lock the legs 20 to the base 18 with the set pins 26. Once the legs 20 are attached to the base 18, the user can level the base using the adjustable levelers 22 and determine whether the base 18 has been suitably leveled by referencing the bubble level 24.

The user can insert the post 16 into the receptacle on the top section 143 of the tower boom 14 and lock the post 16 to the tower boom 14 with the set pins 147. A truss 12 may then be attached to the post 16 and locked in place with set pin 148. A backdrop may then be attached to the truss 12 by any suitable means, such as clips or ties.

The lift 10 may then be extended to a desired height by turning the handle 151 of the winch 15. Once the lift 10 has been extended to the desired height, the tower boom 14 may then be locked at the desired height with the set pins 145 and 146.

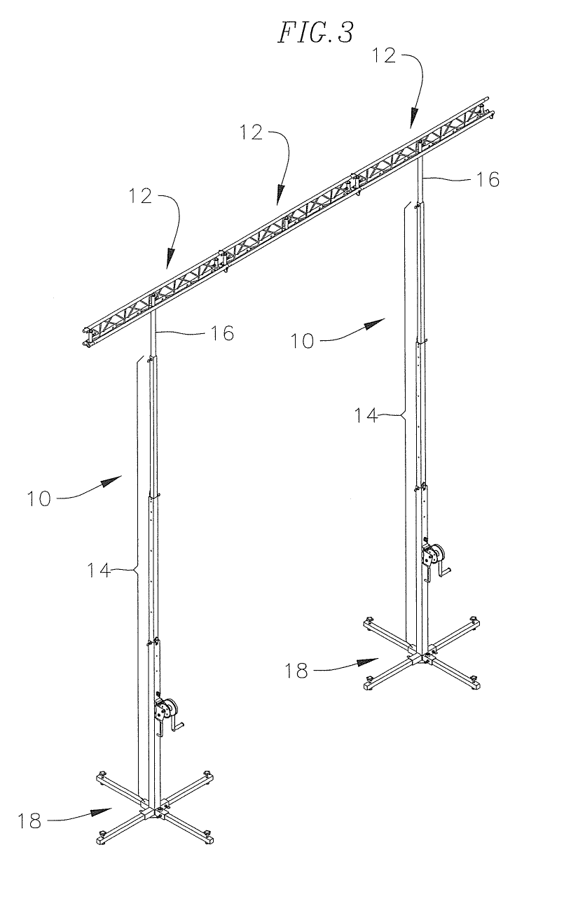

In another embodiment of the present invention shown in FIG. 3, a system of lifts 10 may be utilized to raise longer backdrops. Any suitable number of lifts 10 may be utilized, for example two lifts 10 are shown in FIG. 3. For example, a system of two lifts 10 can support a backdrop of up to about 25 feet in length. Here, a truss segment may be attached to each of the two lifts 10, and up to three truss segments may be mounted between the truss segments attached to the lifts 10 to achieve a desired truss 12 length. A backdrop may then be mounted to the truss 12 as described above.

Once the backdrop is mounted on the truss 12, the lifts 10 may be extended to a desired height. Here, a first operator turns the winch 15 on the first lift 10, and a second operator turns the winch 15 on the second lift 10. The first and second operators turn the winches 15 at a similar speed so that the truss 12 remains level while being raised. The first and second operators may also maintain the truss 12 level while being raised by viewing the indicators 149 on the top section 143 of the tower booms 14. Here, the first and second operators raise the lifts 10 so that the same indicators 149 are visible on both of the lifts 10. For example, if only a “1” indicator is visible on the first lift 10, then only a “1” indicator should be visible on the second lift 10, and the operators may adjust the levels of the lifts 10 accordingly. In another example, if only the “1” and “2” indicators are visible on the first lift 10, then the “1” and “2” indicators should be visible on the second lift 10 and the operators may adjust the levels of the lifts 10 accordingly.

In an embodiment, when the lift 10 is going to be raised to a height of 148 inches with a 30 inch post or less (or 136 inches with an 18 inch post or less), then set pin 145 remains engaged and set pin 146 is pulled so that only the top section 143 is extended as the handle 151 of the winch 15 is turned. Here, the operators will be able to visualize the indicators 149 on the top section 143 as the top section 143 is extended. The operators may then utilize the indicators 149 to determine that the backdrop is being maintained level while it is being raised. The height of the lift 10 may then be fixed by inserting set pin 146.

Further, when the lift 10 is going to be raised to a height greater than 148 inches with a 30 inch post (or 136 inches with an 18 inch post), then both set pin 145 and set pin 146 are pulled so that both the middle section 142 and the top section 143 are extended as the handle 151 of the winch 15 is turned. Here, the middle section 142 will first become fully extended as the handle 151 of the winch 15 is turned. Once the middle section 142 is fully extended, the top section 143 will begin to be extended as the handle 151 of the winch 15 continues to be turned. The operators may then utilize the indicators 149 to determine that the backdrop is being maintained level while it is being raised. The height of the lift 10 may then be fixed by inserting the set pins 145 and 146.

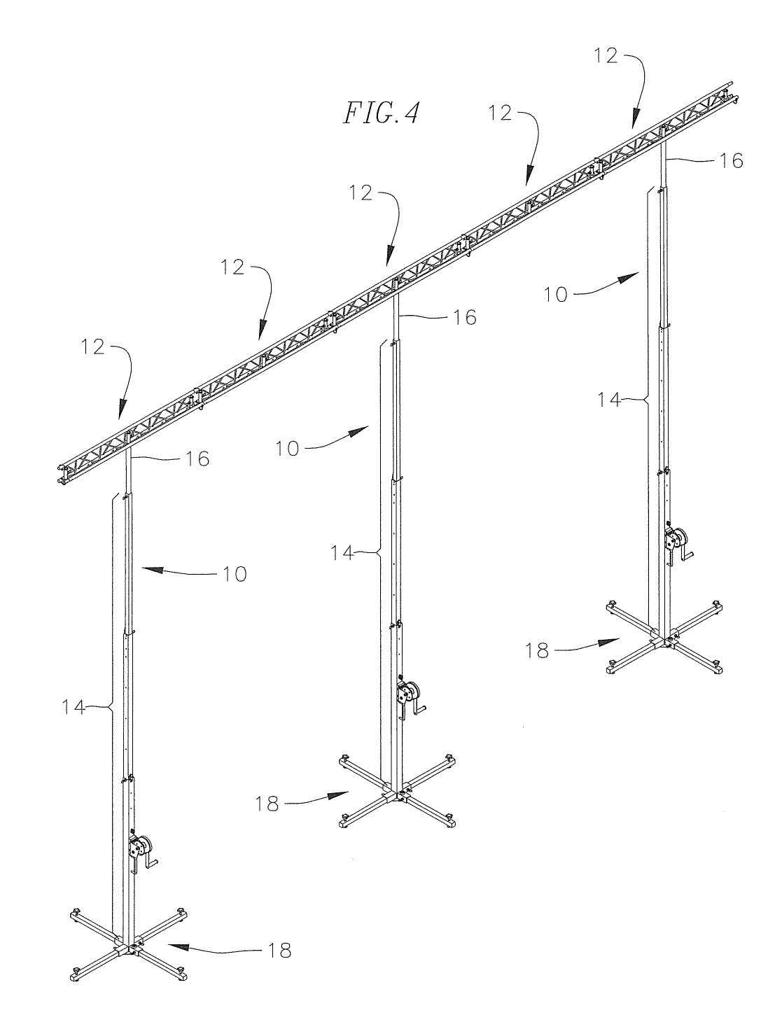

In other embodiments of the present invention, other number of lifts may be utilized in a system. For example, three lifts 10 are shown in FIG. 4. Here, the system of three lifts would be able to support a backdrop of up to about 40 feet in length. The system would be operated in a similar manner to that described above.

To store the lift 10 or a system of lifts 10, each set pin 145 and 146 is pulled to release each section 142 and 143, respectively, of each tower boom 14, and each winch 15 is turned so that each lift 10 is lowered. The backdrop may then be removed from the truss 12. Once the backdrop is removed, the truss 12 may be removed from the posts 16 by pulling the set pins 148 and the truss segments separated from each other by removing the pins 121. Then, each post 16 may be removed from each tower boom 14 by pulling each set pin 147. Finally, the legs 20 may be removed from the bases 18 by pulling the set pins 26. Once the lifts 10 and the truss segments are dismantled, the parts of the lifts 10 and the truss segments may be loaded into a shipping container for storage or shipping.

In an embodiment, the height of the fully retracted tower boom with the post detached is about 70 inches, and the height of the fully extended tower boom with the post attached is about 17 feet. Here, the minimum height of the tower boom is less than about 35% of the height of the tower boom and post. Further, each truss segment is about 5 feet 6 inches long, where the trusses would overlap by about 6 inches, or 3 inches on each end, when they are attached to each other. Here, the truss segments are shorter than the retracted length of the tower boom. These dimensions of the components of the system of lifts allow all of the components to be packed in a container with inner length of 70 inches. Therefore, although the system of lifts is capable of raising a backdrop to 17 feet, the system of lifts may be dismantled into components that may be compactly stored for shipping.

One of ordinary skill in the art will appreciate that the backdrop could be attached to the truss 12 after being raised, and the backdrop could be detached from the truss 12 before being lowered. Further, the posts 16 could be attached to the truss 12 prior to the posts 16 being attached to the tower booms 14, and the truss segments could be attached to each other before or after the truss segments are attached to the posts.

In an embodiment, the lift 10 is constructed of high strength steel. In another embodiment, the lift 10 is constructed of aluminum. In yet another embodiment, the lift 10 weighs about 39 pounds.

While this invention has been described in connection with what are considered to be exemplary embodiments, it is to be understood that the invention is not limited to the disclosed embodiments, dimensions, and configurations, but, on the contrary, also extends to various modifications and equivalent arrangements. The invention is limited only by the claims and their equivalents.

What is claimed is:

1. A lift for raising and lowering a backdrop, the lift comprising:
a base comprising at least three legs;
a tower boom extending substantially vertically from the base and comprising top, middle, and bottom telescoping sections, wherein the tower boom is capable of telescoping from a fully retracted position to a fully extended position; and
a post extending substantially vertically from the tower boom, wherein the post is detachable from the tower boom at a lower end of the post and attachable to a truss adapted for attaching to a backdrop at an upper end of the post,
wherein a minimum height of the tower boom in the fully retracted position is less than about 35% of a maximum height of the tower boom and post, when the tower boom is in the fully extended position.

2. The lift of claim 1, wherein the at least three legs are detachable from the base.

3. The lift of claim 1, wherein the at least three legs are substantially perpendicular to the tower boom.

4. The lift of claim 1, wherein the tower boom further comprises a carrying handle.

5. The lift of claim 1, wherein the base further comprises a level.

6. The lift of claim 1, wherein the at least three legs comprise levelers.

7. The lift of claim 1, further comprising a truss attachable to the post.

8. The lift of claim 1, wherein the top section comprises position indicators along the length of the top section.

9. The lift of claim 1, wherein the tower boom further comprises a brake winch and a cable, wherein the brake winch and the cable are adapted to extend and retract the telescoping sections.

10. The lift of claim 1, wherein a top section of the telescoping sections is adapted to be fixed at one of a plurality locations along the length of the top section with respect to a middle section of the telescoping sections.

11. A system for raising and lowering a backdrop, the system comprising:
at least two lifts, wherein each lift comprises:
a base comprising at least three legs;
an extendable and retractable tower boom extending substantially vertically from the base and comprising top, middle, and bottom telescoping sections, wherein the top section comprises position indicators along a length of the top section for determining whether each tower boom of the at least two lifts is extended or retracted to a substantially similar height; and
a post extending substantially vertically from the tower boom, wherein the post is detachable from the tower boom at a lower end of the post and attachable to a truss at an upper end of the post; and
a truss adapted for attaching to the backdrop and an upper end of each post;
wherein a minimum height of each tower boom in the fully retracted position is less than about 35% of a maximum height of each tower boom and post, when the tower boom is in the fully extended position.

12. The system of claim 11, wherein the truss comprises a plurality of truss segments.

13. The system of claim 12, wherein each of the plurality of truss segments is no longer than the height of the tower boom in a fully retracted position.

14. The system of claim 11, wherein the at least three legs are detachable from the base.

15. The system of claim 11, wherein the at least three legs are substantially perpendicular to the tower boom.

16. The system of claim 11, wherein the tower boom further comprises a carrying handle.

17. The system of claim 11, wherein the base further comprises a level.

18. The system of claim 11, wherein the at least three legs comprise levelers.

19. The system of claim 11, wherein the tower boom further comprises a brake winch and a cable, wherein the brake winch and the cable are adapted to extend and retract the telescoping sections.

20. The system of claim 11, wherein a top section of the telescoping sections is adapted to be fixed at one of a plurality locations along the length of the top section with respect to a middle section of the telescoping sections.
